(19) United States
(12) Patent Application Publication
(10) Pub. No.: US 2004/0204782 A1
(43) Pub. Date: Oct. 14, 2004

(54) Apparatus for analyzing information on golfer's play and method thereof

(76) Inventor: Young Soon Kim, Gyeonggi-do (KR)

Correspondence Address: PORTER WRIGHT MORRIS & ARTHUR, LLP, INTELLECTUAL PROPERTY GROUP, 41 SOUTH HIGH STREET, 28TH FLOOR, COLUMBUS, OH, 43215

(21) Appl. No.: 10/747,660

(22) Filed: Dec. 29, 2003

(30) Foreign Application Priority Data
Jan. 10, 2003 (KR) 2003-0001722

(51) Int. Cl. G06F 155/00

(52) U.S. Cl. 700/92

(57) ABSTRACT

An information analysis apparatus for golfer's play includes a system program memory unit for storing a system program, an input data storage unit, an input unit for inputting information on play, a main processing unit having a microprocessor for processing data and the system program, a display unit for displaying data, and a communication unit for allowing exchange of data with an external device. The input unit preferably includes a key input, a touch screen, a card input, a sensor, an audio signal input, and a video signal input. Play information including information on shots, etc. is analyzed and provided with simple key input without need to write such information into a score card, etc. A golfer's skill is improved and costs are reduced since additional expensive equipment is not required. Play information is analyzed and provided to the golfer on the spot due to portability.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The present invention relates to an apparatus for analyzing information on a golfer's play and method thereof, wherein scores, etc. as well as the contents and results of played shots during golf play are simply recorded on an electronic medium on the spot, and the entire play contents including the contents of shots during golf play or a finish of play are analyzed and provided to a player, and which allows for connection to external device for data exchange.

### BACKGROUND OF THE INVENTION

Generally, conventionally, there was disclosed a method wherein a player directly writes scores into a scorecard provided by a golf course or a caddy writes only scores into the scorecard, or a method of writing only limited information such as the number of putt by using an electronic medium. These methods, however, have problems that the scorecard may be lost during play and a player's recording statistic values cannot be used for analysis, etc. Furthermore, there is not any dedicated device for writing shots.

As one option for solving the aforementioned problems, someone uses a method of inputting play contents written into a note during play again to an additional computer everyday. In this method, a player has to often input the play contents to the computer after the play. However, it is difficult to write lots of play contents occurring in a field into the note one by one. Consequently, this method also has problems that it makes the player troublesome and produces only poor data.

As another option for solving the aforementioned problems, devices such as PDAs, etc. may be used. However, the PDA is complicated in usage, inconvenient and expensive, and requires a user to be accustomed thereto. Only a PDA body is usually provided to a user, by a specific company, for the recruit of new customers and promotion. Thus, there is a problem in that the user must pay service fees. Further, there are problems in that the PDA is bulky, inconvenient to input data, and difficult to carry during golf play.

### SUMMARY OF THE INVENTION

Accordingly, the present invention has been made in view of the above problems, and it is an object of the present invention to provide an apparatus and method for allowing a golfer to take pleasure in playing golf, overcome problems in shots to improve golf skill, and analyze/evaluate all the play contents with less efforts and cost without help from companies or persons that provide predetermined management services, in such a manner that analysis statistic data necessary to improve a golfer's skill, including a ball flight, the direction, a driving distance, etc. regarding shots, and general data necessary for the golfer, including the direction of a putt, the distance of a putt, a lie status, the number of a putt and the like are analyzed and provided to the golfer on the spot.

To achieve the above object, according to the invention, there is provided an information analysis apparatus for a golfer's play, including a power supply unit for supplying desired power supply, a system program memory unit for storing a system program therein, an input data storage unit, an input unit for inputting information on play to the input data storage unit, a main processing unit having a microprocessor for processing the data stored in the input data storage unit and the system program stored in the system program memory unit by using the power supply supplied from the power supply unit, a display unit for displaying the data processed in the main processing unit, and a communications unit for allowing for the exchange of data with an external device.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram illustrating the configuration of an information analysis apparatus for a golfer's play according to an embodiment of the present invention;

FIG. 2 is an exterior view of the information analysis apparatus for a golfer's play that is implemented according to the present invention;

FIGS. 3a and 3b are a flowchart illustrating process steps of an information analysis method using the information analysis apparatus for a golfer's play according to an embodiment of the present invention;

FIG. 4 shows how an initial information input window among the information analysis method using the information analysis apparatus for a golfer's play is implemented;

FIG. 5a shows how an input window for shots among the information analysis method using the information analysis apparatus for a golfer's play is implemented;

FIG. 5b shows how the data inputted to the input window for shots are implemented;

FIG. 6 shows how an input window for putt among the information analysis method using the information analysis apparatus for a golfer's play is implemented;

FIG. 7a shows play results that are analyzed and outputted when play for each hole is finished; and

FIG. 7b shows a total play result that is analyzed and outputted when play for all the holes is finished.

### DETAILED DESCRIPTION OF CERTAIN PREFERRED EMBODIMENTS

Reference will now be made in detail to the preferred embodiments of the present invention, examples of which are illustrated in the accompanying drawings.

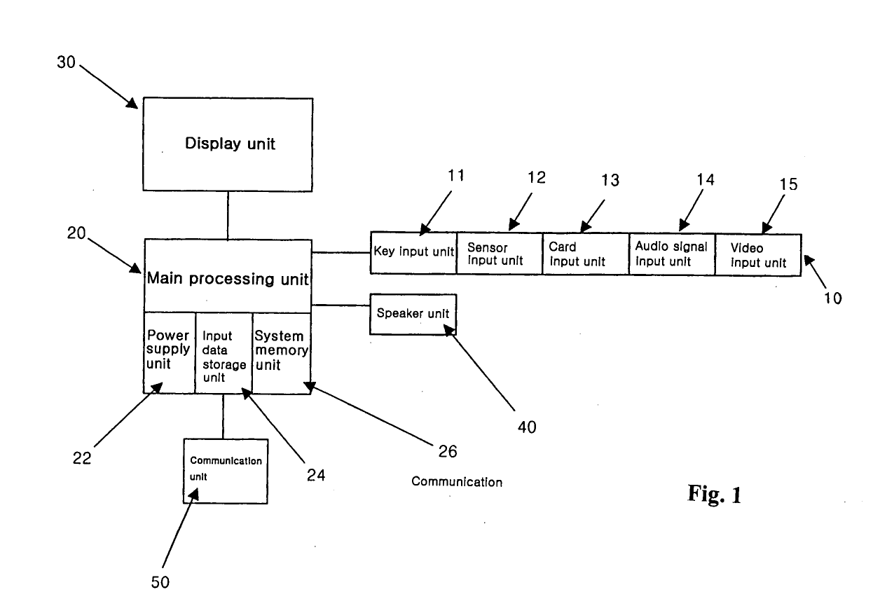

FIG. 1 is a block diagram illustrating the configuration of an information analysis apparatus for a golfer's play.

Referring to FIG. 1, the information analysis apparatus includes a power supply unit 22 for supplying the power supply for driving respective units; an input data storage unit 24 having a memory chip such as SRAM, for storing input data therein; an input unit 10 for inputting relevant information to the input data storage unit 24; a system program memory unit 26 having a flash memory, etc. for storing a system program for operating a main processing unit 20; the main processing unit 20 having a microprocessor, for processing the data stored in the storage unit 24 and the system program stored in the system program memory unit 26 by using the power supply supplied from the power supply unit 22; a display unit 30 such as a LCD, for displaying the data processed in the main processing unit 20; and a communications unit 50 such as a USB port, for allowing for the exchange of data with an external device such as a computer. The power supply unit preferably comprises a battery unit having a primary cell such as a common battery or a secondary cell such as a lead storage battery or a Ni Cd battery.

The input unit 10 includes a key input unit 11 having a direction key and a variety of functional keys, for selecting inputs requested by the display unit 30; a sensor input unit 12 having a sensor, for sensing information on holes, the position of a ball, temperature and the like and then storing the sensed information in the storage unit 24; a card input unit 13 having a card, for reading inputted information and then storing the read information in the storage unit 24; an audio signal input unit 14 for recognizing audio signals and then storing the received signals in the storage unit 24; and a video signal input unit 15 having a camera lens attached thereto, for receiving video signals such as a golfer' shot action, etc. such as a swing as motion picture signnals and then storing the received video signals in the storage unit 24.

In the above, the key input unit 11 may include a direction key and a variety of functional keys that allows all kinds of characters to be inputted, such as electronic dictionaries. The key input unit 11, however, may include about 6 functional keys such as direction, setting, cancellation, completion, etc. This causes the key input unit to be compact and reduces the costs.

The sensor input unit 12 has a function of sensing information on temperature, the position of a ball, and the like. In case of temperature, the sensor input unit 12 uses a temperature sensor to sense current temperature. In case of positional information, the sensor input unit 12 uses a probe sensor capable of sensing a predetermined material such as a metal to sense signals transmitted from a ball made of a predetermined material such as a metal, thereby exactly locating the position of the ball.

The card input unit 13 allows new analyzed information to be inputted to the storage unit 24, through the card in which course information by a golf course or information related to play is recorded. This can be simply performed by inserting the card into a reader machine of the card input unit 13 without connection to an external computer. This card input unit can thus be conveniently employed even at overseas golfer courses.

The audio signal input unit 14 converts audio signals inputted via the microphone into digital signals, compresses the digital signals, and causes the compressed signal to be stored in the storage unit 24.

The video signal input unit 15 converts video signals inputted via the camera into compressed digital signals and then causes the digital signals to be stored in the storage unit 24.

The main processing unit 20 has the microprocessor, which is operated by the power supply from the power supply unit 22 and requests data to be inputted to the input data storage unit 24 or processes data inputted to the input data storage unit 24. The main processing unit 20 performs such a function under the control of the system program.

The input data storage unit 24 preferably consists of an EEPROM into and/or from which data can be written and/or read by predetermined control signals of Read/Write, which satisfy two conditions that a user can limitedly update the data stored in the EEPROM and the data stored therein are not erased even when the power is off.

The system program memory unit 26 includes the system program that is basically needed for the booting. It is thus preferred that the memory unit 26 is composed of a ROM from which data are not arbitrarily erased by a user and are not erased even when the power is off.

The display unit 30 may be implemented using a liquid crystal display (LCD) for displaying the output of an input window for data that will be inputted according to the system program and the output of analyzed results. Furthermore, the display unit 30 functions as both an output unit and an input unit. The function as the input unit of the display unit 30 can be implemented using the touch screen function that allows desired data to be inputted by pressing the screen with a pen or a finger.

The information analysis apparatus of the present invention further includes a speaker unit 40, as shown in FIG. 1. The speaker unit 40 functions to decompress compressed signals stored in the audio signal input unit 14, and then output the decompressed signals as audio signals, or output information useful for play as audio signals on the basis of analysis into data of the input unit 10 and resulting play data.

The communications unit 50 is connected to the external device such as the computer. The communications unit 50 has information related to golf play, for example, information on courses in a golf course, etc. At this time, transmission/reception of the external device may be accomplished through a USB port or an IrDA infrared port, an IEEE1394 connector, and GPS communications rules.

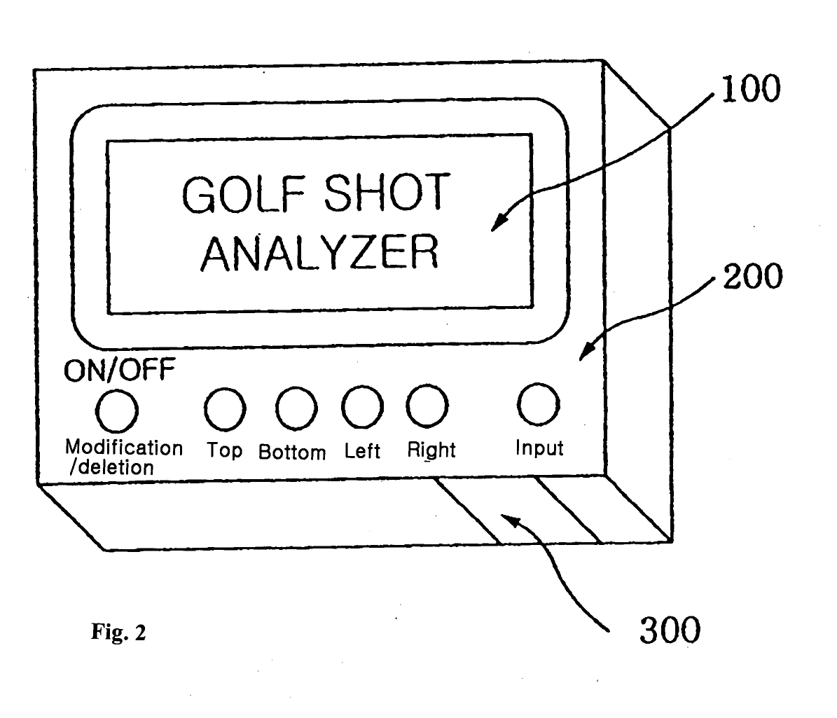

FIG. 2 is an exterior view of the information analysis apparatus for a golfer's play that is implemented according to the present invention.

As shown in FIG. 2, the information analysis apparatus includes a liquid display unit 100 having a LCD for allowing data to be inputted and pictures or characters, etc. to be outputted, by the touch screen function, and a body unit 200 having a variety of input keys installed on a casing including the main processing unit and the storage unit.

The body unit 200 has a microprocessor chip, a power driver unit, a memory chip and the like built in for performing analysis works, and a communications unit such as a USB port for the exchange of data with the external computer.

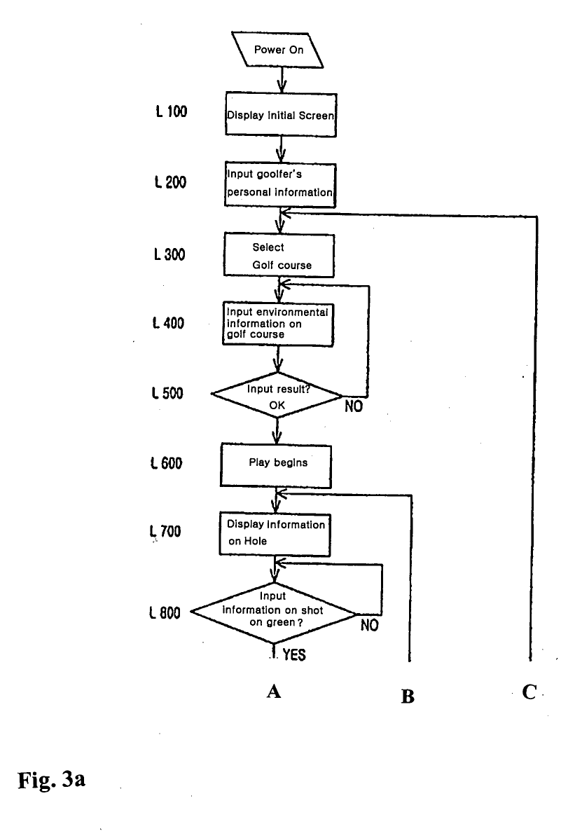

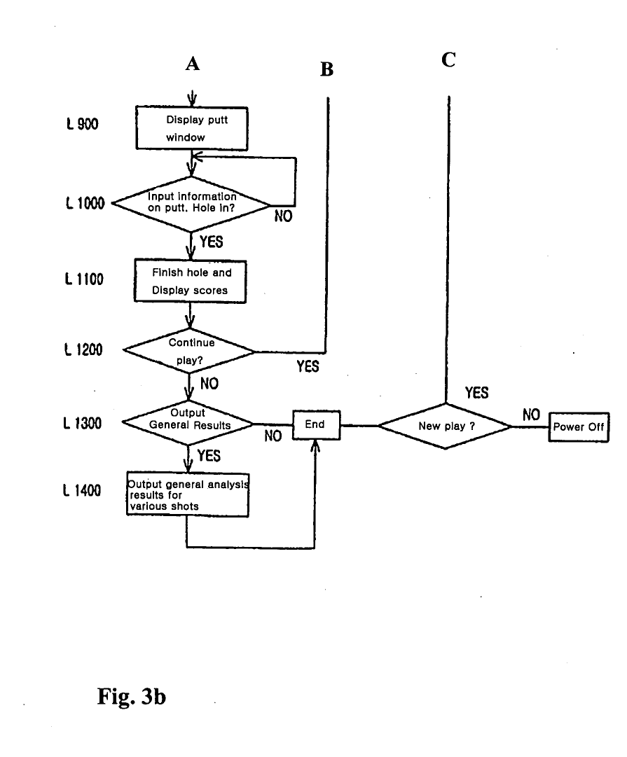

FIGS. 3a and 3b are a flowchart illustrating process steps of an information analysis method using the information analysis apparatus for a golfer's play according to an embodiment of the present invention.

Referring to FIGS. 3a and 3b, after the power is on, an initial screen is displayed (L100). If a golfer inputs personal information (the types of clubs to use, a driving distance by a club, handicaps, etc.) before play begins (L200), a window for selecting a golf course is displayed. If the golfer selects a predetermined golf course (L300), a window for inputting environmental information on the selected golf course is displayed. If the environmental information is inputted (L400), the inputted information is compared with information stored in the apparatus (L500). If it is determined that they are identical, the process goes to the process of inputting play information (L600). Meanwhile, if it is determined that they are not identical, the process of inputting environmental information on a corresponding golf course (L400) is repeated. At this time, if golf courses and environmental information on golf courses are not provided by the apparatus, the golfer may directly input new environment information. In the step of inputting play information after play begins (L600), information on a hole is displayed on the display unit (L700) and information on the results of shots from the tee shot to the green is then inputted (L800). If the information on the shots is inputted in step L800, an input window for inputting data on the remaining distance until the ball is landed on the green and a next shot based on the information on the hole, is repeatedly displayed. If the ball is safe landed on the green, a putt window is displayed (L900). An input window for inputting the distance between the ball safe landed on the green and the pin, which is usually measured by strides, is displayed (L1000). In this case, the input window is repeatedly provided until the ball enters the hole cup. Once the ball enters the hole cup, play of one hole is finished (L1100). After the play of one hole is finished, it is determined whether the play will continue (L1200). The results that play contents until the hole are analyzed and the results that information on the hole for which the play wad finished until the hole is accumulated/analyzed, are then outputted (L1300). If play of 18 holes is finished, a general analysis screen for a variety of shots is provided through analysis (L400).

In step L400 for inputting environmental information on a selected golf course, an input window for inputting a play date, a tee-off time, temperature, weather, the direction and velocity of the wind, a course name, the type of a tee box, the position of a green (left or right), the position of a pin and the like is displayed on the display unit. A user can then input relevant information through a touch screen function or input keys of the input window.

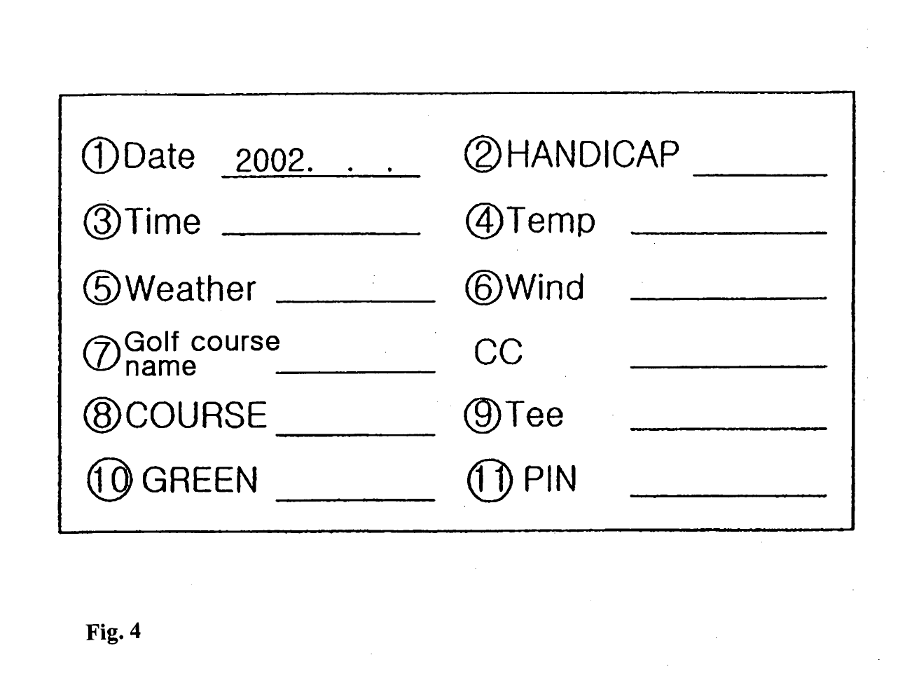

Step L400 will now be described in detail with reference to FIG. 4, which shows how the initial information input window among the information analysis method using the information analysis apparatus for a golfer's play is implemented.

As can be seen from FIG. 4, an input window for inputting a title and contents on desired data that will be inputted to the display unit is displayed. The user then inputs corresponding contents corresponding to the contents using the direction key, the functional key, etc., or selects corresponding contents using the touch screen function, thus inputting the contents for the corresponding contents.

In step for inputting the information on the shots (L800), if information on the result from the tee shot after play begins to when the ball is safe landed on the green is inputted, the input window for inputting data on the remaining distance and a next shot based on the information on the hole is displayed. More particularly, in step L800, the input window for inputting a variety of information on the type of clubs used in respective shots, the driving distance, the direction of the ball (center, right, left), a place where the ball is dropped (whether the ball is in a fairway, the rough or hazards), and whether the ball is out of bounds (OB), is displayed under the control the system program that operates the information analysis apparatus, so that those information can be inputted through the input key, the touch screen or audio. Furthermore, in this step, information on the surface of land where the shot is made (an upward slope, a downward slope, flatland, etc.) can be inputted and the penalty in case of OB and hazards can be automatically calculated.

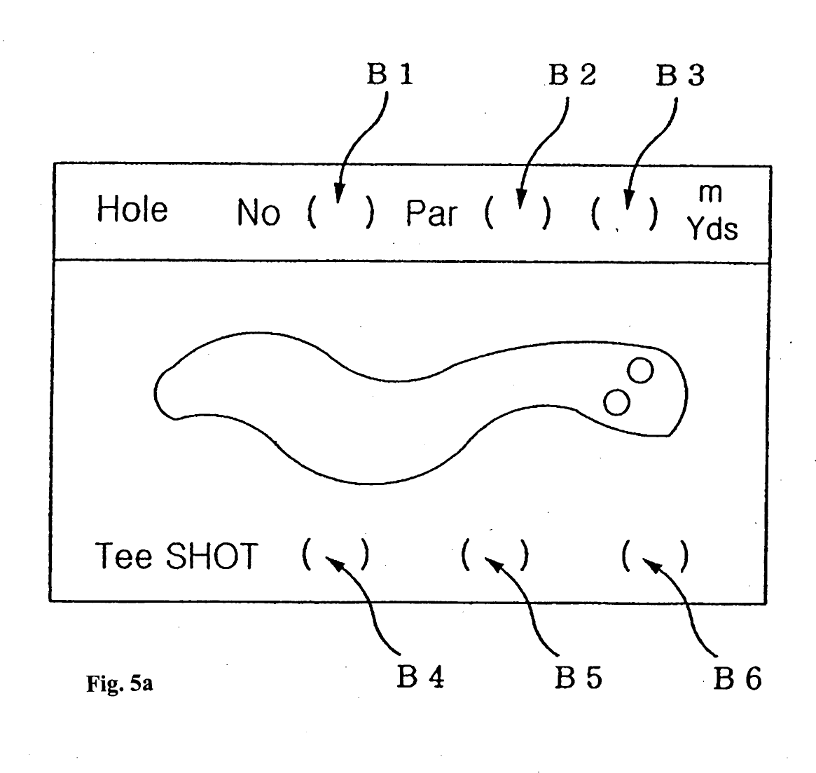

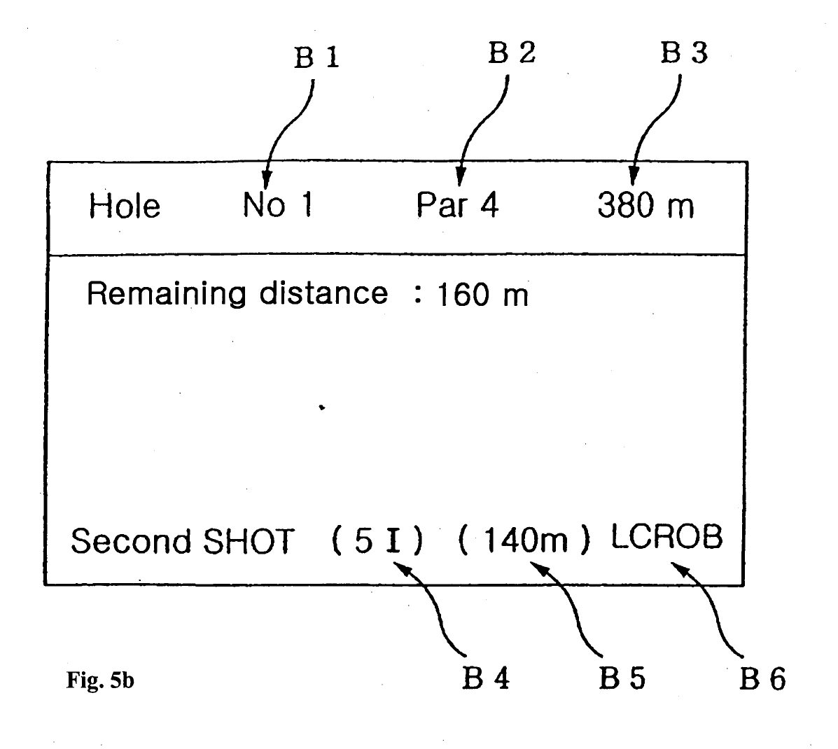

This will be described in detail with reference to FIGS. 5a and 5b. FIG. 5a shows how the input window for shots among the information analysis method using the information analysis apparatus for a golfer's play is implemented.

As shown in FIG. 5a, if there is no information on a hole, the input window for inputting data on the number of a given hole, the distance or the number of a par is displayed on the display unit. Those data can be thus inputted using the input key or the touch screen function of the window. However, if there is already information on the hole in step (L400), a golfer does not need to further input corresponding information.

FIG. 5b shows a state where all the data requested by the input window of FIG. 5a are inputted and displayed on the display unit.

If the ball is safe landed on the green, the information analysis apparatus of the present invention automatically recommends a golfer a suitable putter. In step (L1000), the putt window until the ball enters the hole cup is repeatedly displayed. More particularly, the input window for inputting information on lie conditions (a downward slope, an upward slope, a flatland, a hook lie, a slice lie, etc.) for each putt, the distance measured by strides, and the direction is displayed under the control of the system program that operates the information analysis apparatus. Play results are then inputted using the input key, the touch screen or voice. In this putt step, if a golfer selects a Hole Cup among positions provided by the input window, the information analysis apparatus displays “O.K” or the result indicating that one hole is finished, provides analysis data on corresponding hole after the hole is finished, and then automatically proceeds to a next hole. Then, the above processes are repeated, which is repeatedly performed until all the holes are finished.

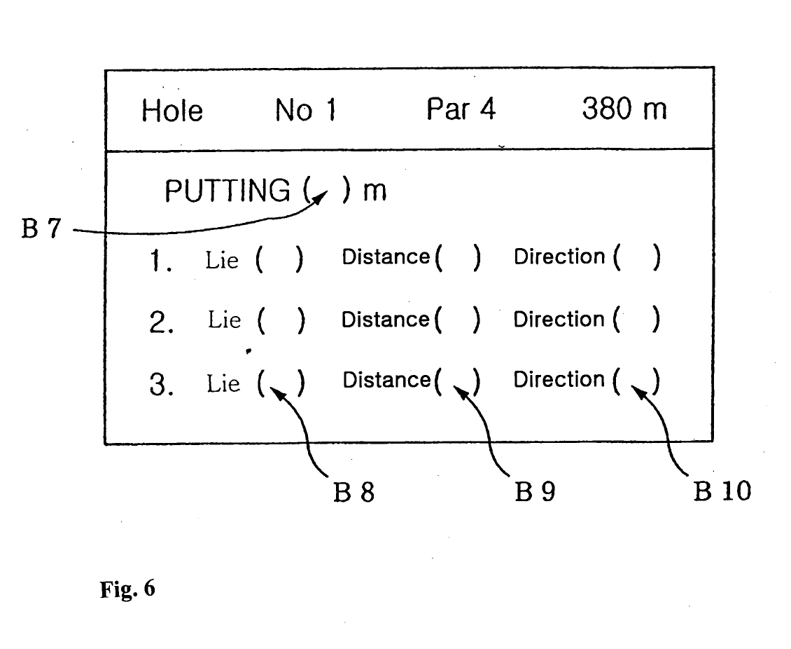

Hereinafter, the step of inputting putt information (L1000) will be described in detail with reference to FIG. 6.

FIG. 6 shows how the input window for putt among the information analysis method using the information analysis apparatus for a golfer's play is implemented.

As shown in FIG. 6, the input window for inputting information on lie conditions, a putt distance and a putt direction until each putt is successful is displayed on the display unit. Play results are then inputted using the input key or the touch screen.

In the step of analyzing and outputting the results for the hole (L130), input data for all the past holes as well as a hole that has been just finished are accumulated, analyzed and outputted.

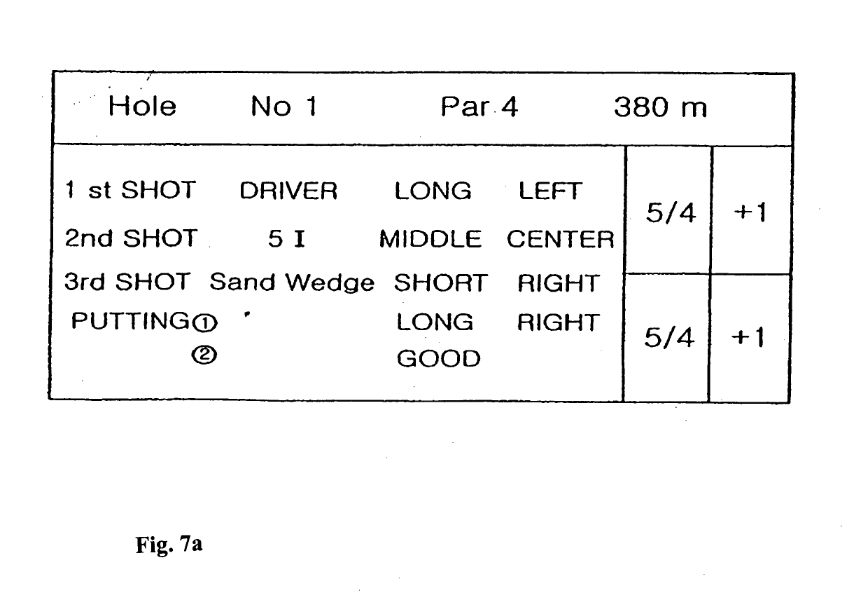

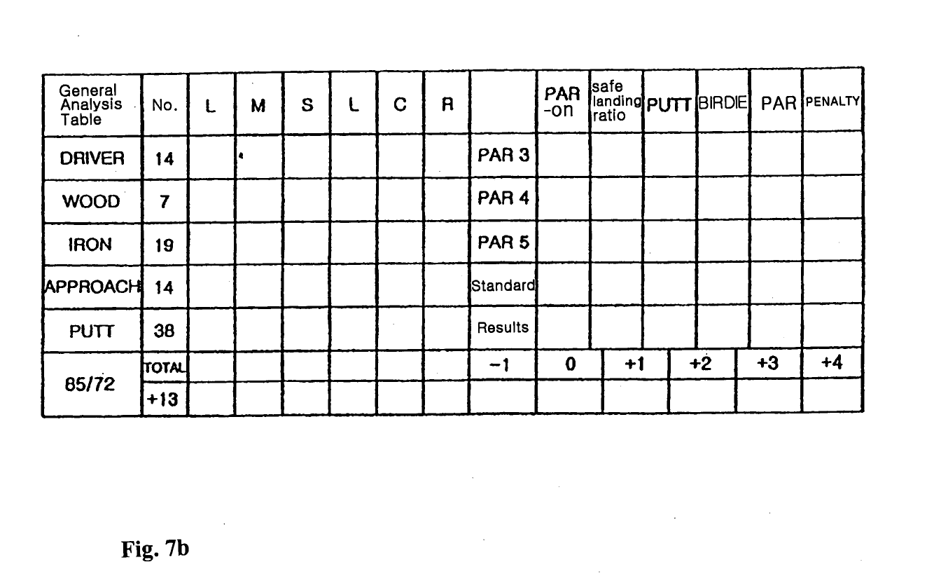

How the step of analyzing and outputting the results for the hole (L1300) can be displayed on the display unit according to an embodiment of the present invention, will be described with reference to FIG. 7a.

In step (L1400), if play of all the holes is finished, general results are provided to the golfer based on the analyzed result for each hole. More particularly, the golfer is provided with detailed data on scores by holes, the fairway safe landing ratio, the green hit ratio, the number of miss shots, the number of penalty, the number of a birdie, the number of a par, putt and the like under the control of the system program that operates the information analysis apparatus. Further, the golfer is informed of problems considering handicaps, so that the golfer can improve skill. In this step, information on the driving distance, the direction, miss shots and the like for driver shots, wood shots, iron shots, etc. is analyzed and provided to the golfer.

How the results of step (L1400) can be displayed on the display unit according to an embodiment of the present invention will be described with reference to FIG. 7b.

It is evident that the information analysis method for a golfer's play can be contented and thus be applied to other devices such as mobile communications terminals, PDAs and the like.

As described above, according to an information analysis apparatus for a golfer's play and method thereof, play information on shots, etc. can be analyzed and provided with simple key input without the need to write such information into the score card, a note, etc. Therefore, the present invention has new effects that it can help to improve a golfer's skill and reduce costs since additional expensive equipments are not needed. Furthermore, the present invention has a further effect that play information can be analyzed and provided to a golfer on the spot due to portability.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An information analysis apparatus for a golfer's play, comprising:
a system program memory unit for storing a system program therein, which drives a main processing unit;
an input data storage unit for storing inputted data therein;
an input unit for inputting information on play to the input data storage unit;
the main processing unit having a microprocessor, for processing the data stored in the input data storage unit and the system program stored in the system program memory unit by using the power supply supplied from the power supply unit;
a display unit for displaying the data processed in the main processing unit;
a speaker unit for outputting audio signals;
a communications unit for allowing for the exchange of data with an external device; and
a power supply unit for supplying power supply that drives the respective units.

2. The information analysis apparatus as claimed in claim 1, wherein the power supply unit comprises a battery unit having at least one of a primary cell and a secondary cell.

3. The information analysis apparatus as claimed in claim 1, wherein the input unit comprises:
a key input unit having buttons, for directly receiving data and storing the received data in the storage unit;
a sensor input unit having a sensor, for sensing information on holes, a driving distance, a position of a ball, and temperature, and storing the sensed information in the storage unit;
a video signal input unit having a camera lens mounted in, for receiving a golfer's actions as motion picture signals and then storing the received signals in the storage unit;
a card input unit having a card, for reading inputted information and then storing the read information in the storage unit; and
an audio signal input unit for recognizing audio signals and then storing the received signals in the storage unit.

4. The information analysis apparatus as claimed in claim 3, wherein the key input unit comprises a direction key for moving a cursor in top, bottom, right and left directions, and functional keys of setting, cancellation, and completion.

5. The information analysis apparatus as claimed in claim 3, wherein the sensor input unit comprises a probe sensor for sensing a special material, wherein the probe sensor uses signals sent from a ball made of the special material to locate the position of the ball, and then stores the located position of the ball in the storage unit.

6. The information analysis apparatus as claimed in claim 1, wherein the display unit comprises a touch screen for receiving new data.

7. The information analysis apparatus as claimed in claim 1, wherein the communication unit comprises at least one of a USB port and an IrDA infrared port, an IEEE1394 connector, and GPS communications rules, for the exchange of data with the external device.

8. An information analysis method for a golfer's play, comprising the steps of:
(a) displaying an initial screen;
(b) inputting a golfer's personal information;
(c) selecting or inputting a golf course;
(d) inputting environmental information on the golf course for play;
(e) displaying information on a hole;
(f) if data on shots are inputted, displaying an input window for inputting data on the remaining distance and a next shot based on the information on the hole;
(g) if a ball is safe landed on a green, automatically changing the existing window to a putt window;
(h) displaying an input window for inputting data on putt shots until the ball enters a hole cup;
(i) if the ball enters the hole cup, displaying that the hole is finished;
(j) analyzing results of the shots in the finished hole and then providing analyzed results to the golfer;
(k) if play for all holes is finished, providing the golfer with a general analysis screen; and
(l) providing information helpful to the golfer's play in the step of inputting information on the shots and the step of inputting information on the putt, based on the general analysis screen.

9. The information analysis method as claimed in claim 8, wherein step (a) includes providing information on time, temperature, and direction of wind.

10. The information analysis method as claimed in claim 8, wherein steps (b) to (d) include:
receiving data on a play date, a golfer's handicap, a tee-off time, temperature, weather, direction and velocity of wind, a course name, type of a tee, shape of a green, position of a pin, and a hole via an input window displayed on a display unit through an input key or a touch screen of the window;
receiving the data from an external device via a communication unit; and
receiving the data through a card input unit.

11. The information analysis method as claimed in claim 8, wherein step (f) includes displaying, on a display unit, the input window for inputting data on the type of a club used in each shot, a driving distance by each club, a ball flight, a direction of a ball (center, right, left), a place where the ball is dropped (fairway, rough, bunker, hazard), whether the ball is out of bounds, direction and velocity of wind, and surface status of land (upward slope, downward slope, flatland) under the control of a system program that operates an information analysis apparatus, and inputting data desired by the display unit through an input key, a touch screen or audio.

12. The information analysis method as claimed in claim 8, wherein step (h) includes inputting information on a distance measured by strides and a direction

13. The information analysis method as claimed in claim 8, wherein step (h) includes displaying, on a display unit, the input window for inputting information on lie conditions for each putt, a distance and direction, until the putt is successful under a system program that operates an information analysis apparatus, and inputting data desired by the display unit through an input key, a touch screen or voice.

14. The information analysis method as claimed in claim 8, wherein step (l) includes informing the golfer of suitable clubs, a shot direction, and a distance through characters and voice, when information on the shots are input.
